(19) United States
(12) Patent Application Publication
(10) Pub. No.: US 2024/0383041 A1
(43) Pub. Date: Nov. 21, 2024

(54) ADDITIVE MANUFACTURING APPARATUS AND METHOD FOR METAL ADDITIVE MANUFACTURED PRODUCTS

(71) Applicant: Mitsubishi Electric Corporation, Tokyo (JP)

(72) Inventors: Yasutomo TANIHARA, Tokyo (JP); Daiji MORITA, Tokyo (JP); Takafumi FUJII, Tokyo (JP); Nobuyuki SUMI, Tokyo (JP)

(73) Assignee: Mitsubishi Electric Corporation, Tokyo (JP)

(21) Appl. No.: 18/693,542

(22) PCT Filed: Oct. 19, 2021
(86) PCT No.: PCT/JP2021/038639

§ 371 Date: Mar. 20, 2024

(51) Int. Cl. B22F 10/368; B22F 10/28; B22F 12/90; B23K 26/03; B33Y 10/00; B33Y 30/00; B33Y 50/02

(52) U.S. Cl. CPC B22F 10/368; B22F 10/28; B22F 12/90; B23K 26/034; B33Y 10/00; B33Y 30/00; B33Y 50/02; B22F 2201/10; B22F 2301/205

(57) ABSTRACT

An additive manufacturing apparatus for metal additive manufactured products supplies material of the metal additive manufactured products to a processing region, performs irradiation with a heat source that melts the supplied material, ejects a shielding gas to the processing region, and measures a temperature at a measurement point in the processing region. When the temperature at the measurement point during processing reaches a temperature set on the basis of an oxidation temperature of the material, a control device performs at least one of control of stopping the output of the heat source, control of reducing the output, or control of reducing the speed of movement or stopping the movement of the heat source moving in the processing region.

### FIELD

The present disclosure relates to an additive manufacturing apparatus and method for metal additive manufactured products that manufacture a metal additive manufactured body.

### BACKGROUND

Conventionally, as a technique for processing a three-dimensional object, an additive manufacturing apparatus for metal additive manufactured products using a technique called additive manufacturing (AM) is known. Patent Literature 1 discloses a manufacturing system for metal additive manufactured products that repeatedly melts a wire in the form of droplets and deposits the droplets on a substrate to obtain products having a desired shape. In the manufacturing system described in Patent Literature 1, the wire as a processing material is irradiated with a laser beam so that the droplets are formed at a tip of the wire. The droplets are then deposited in a molten pool formed on a surface of the substrate, whereby the products are formed. In the vicinity of the droplets at the tip of the wire, an inert gas called a shielding gas is blown to inhibit oxidation of the material.

In such an additive manufacturing apparatus for metal additive manufactured products, when the process is continuously continued in the atmosphere, heat storage of the products are accumulated. Then, the products are oxidized because of the lack of shielding gas. The oxidation of the products leads to problems such as a failure to fulfill a predetermined material standard and a decreasing of material propriety. For example, titanium alloys are known to have reduced ductility of the material as increasing oxygen content.

In view of the above problems, for example, the additive manufacturing apparatus for metal additive manufactured products performs processing in some cases by replacing the atmosphere in the entire processing range with a vacuum atmosphere or the inert gas. In such a system, there is no concern for oxidation of the products when heat storage is accumulated.

In order to inhibit oxidation of the products, one can conceive a nozzle that increases the area of local injection of the shielding gas. However, in recent years, various sensors are placed near the melting area for improvement of processing accuracy. The sensors interfere the enlarged nozzle. An additive manufacturing apparatus for metal additive manufactured products described in Patent Literature 2 performs temperature measurement, but none of the above remedies material oxidation.

### CITATION LIST

### Patent Literature

Patent Literature 1: WO 2020-079870
Patent Literature 2: Japanese Patent Application Laid-open No. 2021-028074

### SUMMARY OF INVENTION

### Problem to be Solved by the Invention

However, replacing the atmosphere in the entire processing range of these additive manufacturing apparatuses for metal additive manufactured products with the vacuum atmosphere or inert gas atmosphere has had problems such as consuming a large amount of gas and requiring time for the replacement.

The present disclosure has been made to solve the above problems, and an object of the present disclosure is to provide an additive manufacturing apparatus and method for metal additive manufactured products that is not oxidized even in the atmosphere.

### Means to Solve the Problem

An additive manufacturing apparatus for metal additive manufactured products according to the present disclosure includes: a material supply unit to supply a material of the metal additive manufactured products to a processing region; an irradiation unit to irradiate the processing region with a heat source that melts the material; a gas supply unit to eject a shielding gas to the processing region; a temperature measurement unit to measure a temperature at a measurement point in the processing region; and a control device to perform, when the temperature at the measurement point during processing reaches a temperature set on the basis of an oxidation temperature of the material, at least one of control of stopping output of the heat source with which the processing region is irradiated, control of reducing the output, or control of reducing a speed of movement or stopping the movement of the heat source moving in the processing region.

An additive manufacturing method for metal additive manufactured products according to the present disclosure includes: a step of supplying a material of the metal additive manufactured products to a processing region; a step of irradiating the processing region with a heat source that melts the material; a step of ejecting a shielding gas to the processing region; a step of measuring a temperature at a measurement point in the processing region; and a step of performing, when the temperature at the measurement point during processing reaches a temperature set on the basis of an oxidation temperature of the material, at least one of control of stopping output of the heat source with which the processing region is irradiated, control of reducing the output, or control of reducing a speed of movement or stopping the movement of the heat source moving in the processing region.

### Effects of the Invention

The additive manufacturing apparatus and method for metal additive manufactured products according to the present disclosure has an effect of being able to inhibit oxidation of products processed in air atmosphere.

### BRIEF DESCRIPTION OF DRAWINGS

FIG. 1 is a schematic diagram illustrating an additive manufacturing apparatus for metal additive manufactured products according to a first embodiment of the present disclosure.

FIG. 2 is a schematic cross-sectional view illustrating a deposition region of the additive manufacturing apparatus for metal additive manufactured products according to the first embodiment of the present disclosure.

FIG. 3 is a block diagram illustrating a hardware configuration of a control device according to the first embodiment of the present disclosure.

FIG. 4 is a schematic graph illustrating a result of a mass increase per temperature of material/raw material in a thermogravimetric/differential thermal analyzer according to the first embodiment of the present disclosure.

FIG. 5 is a schematic cross-sectional view illustrating the deposition region of the additive manufacturing apparatus for metal additive manufactured products for explaining a temperature measurement range according to the first embodiment of the present disclosure.

FIG. 6 is a schematic cross-sectional view illustrating the deposition region of the additive manufacturing apparatus for metal additive manufactured products for explaining the temperature measurement range according to the first embodiment of the present disclosure, where the position of a processing head is moved from that in FIG. 5.

FIG. 7 is a set of flowcharts for explaining an operation of the additive manufacturing apparatus for metal additive manufactured products according to the first embodiment of the present disclosure.

FIG. 8 is a result of a mass increase per temperature of Ti alloys in the thermogravimetric/differential thermal analyzer according to the first embodiment of the present disclosure.

FIG. 9 is a schematic cross-sectional view illustrating the deposition region of the additive manufacturing apparatus for metal additive manufactured products for explaining oxygen concentration measurement points according to a first example of the first embodiment of the present disclosure.

FIG. 10 is oxygen concentration measurement results at different measurement points according to the first example of the first embodiment of the present disclosure.

FIG. 11 illustrates the deposition region of the additive manufacturing apparatus for metal additive manufactured products for explaining a line bead according to a second example of the first embodiment of the present disclosure.

FIG. 12 illustrates the deposition region of the additive manufacturing apparatus for metal additive manufactured products for explaining a ball-shaped bead according to a third example of the first embodiment of the present disclosure.

FIG. 13 illustrates the deposition region of the additive manufacturing apparatus for metal additive manufactured products for explaining a segment bead according to a fourth example of the first embodiment of the present disclosure.

FIG. 14 is a set of schematic diagrams illustrating how the processing head for the metal additive manufactured products and the products are moved for explaining a fill pass according to a fifth example of the first embodiment of the present disclosure.

FIG. 15 illustrates a deposition region of an additive manufacturing apparatus for metal additive manufactured products for explaining a measurement point of an interpass temperature according to a second embodiment of the present disclosure.

FIG. 16 is a schematic graph illustrating a relationship between the interpass temperature and an oxidation temperature for each laser output according to the second embodiment of the present disclosure.

FIG. 17 is a flowchart for explaining an operation of the additive manufacturing apparatus for metal additive manufactured products according to the second embodiment of the present disclosure.

FIG. 18 illustrates a deposition region of an additive manufacturing apparatus for metal additive manufactured products for explaining a measurement point of a depositing point temperature and placement of a temperature measurement unit according to a third embodiment of the present disclosure.

FIG. 19 is a schematic graph illustrating a relationship between the depositing point temperature and an oxidation temperature for each laser output according to the third embodiment of the present disclosure.

FIG. 20 is a flowchart for explaining an operation of the additive manufacturing apparatus for metal additive manufactured products according to the third embodiment of the present disclosure.

### DESCRIPTION OF EMBODIMENTS

Hereinafter, an additive manufacturing apparatus and an additive manufacturing method for metal additive manufactured products according to embodiments of the present disclosure will be described in detail with reference to the drawings. Note that the present invention is not limited to the embodiments.

### First Embodiment

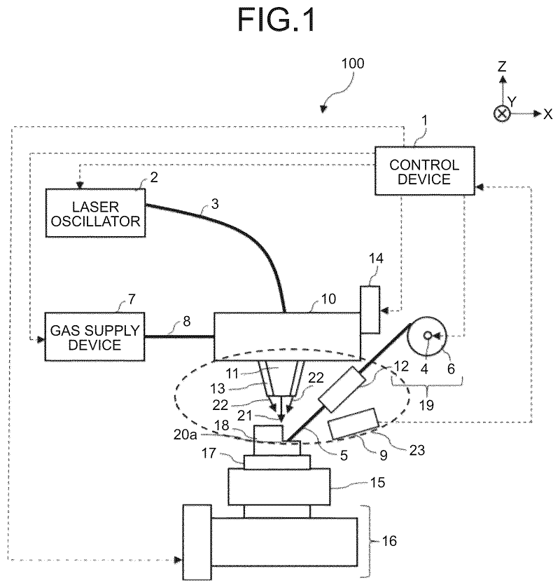

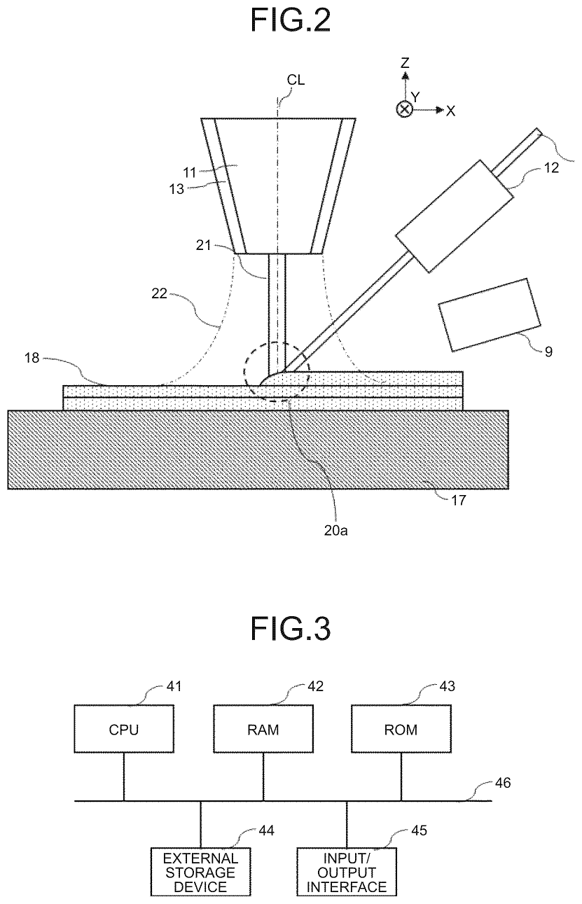

FIG. 1 is a schematic diagram of an additive manufacturing apparatus for metal additive manufactured products according to a first embodiment of the present disclosure. FIG. 2 is a schematic diagram illustrating a deposition region 23 according to the first embodiment of the present disclosure. A material melted by laser irradiation is deposited and stacked on a symmetry surface of a substrate, whereby a three-dimensional shaped object is manufactured. In the present embodiment, a beam is a laser beam 21, and the material is a wire 5 that is a processing material and a metal material in the form of a wire. Note that a heat source is not limited to the laser beam, and an arc may be used as the heat source. The form of the metal material is not limited to the wire either, and may be powder.

An equipment of an additive manufacturing apparatus 100 for metal additive manufactured products will be described with reference to FIGS. 1 and 2. The additive manufacturing apparatus 100 for metal additive manufactured products deposits beads on a substrate 17. The bead is formed by solidification of the wire 5 melted, and the bead which is deposited on a substrate call the deposition 18. When the deposition is deposited in a desired shape, a desired three-dimensional additive manufactured product can be produced.

The substrate 17 is placed on a stage 15. The proceed material refers to the substrate 17 or the deposition 18. The products refer to the deposition 18 produced with following a processing program. The substrate 17 illustrated in FIG. 1 is a plate material. The substrate 17 may be something other than the plate material.

The additive manufacturing apparatus 100 for metal additive manufactured products includes a processing head 10 including a beam nozzle 11, a wire nozzle 12, and a gas nozzle 13. The beam nozzle 11 emits the laser beam 21, which is the heat source for melting the material, toward the substrate or the proceed material. The wire nozzle 12 inserts the wire 5 toward an irradiation position of the laser beam 21 on the substrate. The gas nozzle 13 ejects a shielding gas 22 for inhibiting oxidation of the deposition 18 toward the substrate. In the first embodiment, the shielding gas 22 is an inert gas represented by argon or nitrogen. The beam nozzle 11, the wire nozzle 12, and the gas nozzle 13 are fixed to the machining head 10 so that a positional relationship thereamong is uniquely determined. That is, the processing head 10 fixes the relative positional relationship among the beam nozzle 11, the wire nozzle 12, and the gas nozzle 13. The shielding gas 22 is ejected from the center of the laser in a case described below, but may be ejected from a device attached to the processing head 10.

The additive manufacturing apparatus 100 for metal additive manufactured products includes a temperature measurement unit 9. The temperature measurement unit 9 measures the temperature of the deposition region 23. The temperature measurement unit 9 measures, for example, the temperature of the deposition 18. In this case, a thermoviewer or a radiation thermometer is used as the temperature measurement unit 9, but other measuring equipment may be used. The temperature measurement unit 9 may be coaxial with the processing head 10 or may be a standalone unit. When the temperature of the products is measured by the temperature measurement unit 9, we can monitor the temperature of the products in process.

An irradiation unit irradiates the deposition region 23 with the heat source that melts the material of a metal stacked body. For example, the irradiation unit irradiates the deposition region 23 with the laser beam 21 that melts the wire 5 as the material, and includes a laser oscillator 2, a fiber cable 3, and the beam nozzle 11. The laser oscillator 2 causes the laser beam 21 to oscillate. The laser beam 21 from the laser oscillator 2 as a beam source propagates to the processing head 10 through the fiber cable 3 as an optical transmission line.

A gas supply unit ejects the shielding gas 22 to the deposition region 23. The gas supply unit includes, for example, a gas supply device 7, a pipe 8, and the gas nozzle 13. The gas supply device 7 supplies gas to the gas nozzle 13 through the pipe 8.

A material supply unit 19 supplies the material of the metal additive manufactured products to the deposition region 23. The material supply unit 19 includes, for example, a rotary motor 4, a wire spool 6, and the wire nozzle 12. The wire spool 6 around which the wire 5 is wound is a source of supply of the material. The wire spool 6 rotates with the driving of the rotary motor 4 that is a servomotor, whereby the wire 5 is fed out from the wire spool 6. The wire 5 fed out from the wire spool 6 passes through the wire nozzle 12 and is supplied to the irradiation position of the laser beam 21. Also, when the rotary motor 4 is reversely rotated in a direction reverse to that in feeding out the wire 5 from the wire spool 6, the wire 5 supplied to the irradiation position of the laser beam 21 can be pulled out from the irradiation position of the laser beam 21. In this case, a portion of the wire 5 that is fed out from the wire spool 6 close to the wire spool 6 is taken up by the wire spool 6.

The additive manufacturing apparatus 100 for metal additive manufactured products includes at least one of the rotary motor 4 of the wire spool 6 and an operation equipment of the wire nozzle 12, thereby being able to supply the wire 5 to the irradiation position of the laser beam 21. FIG. 1 omits the illustration of the operation equipment of the wire nozzle 12.

A head driver 14 moves the machining head 10 in directions of a X axis, a Y axis, and a Z axis. The X axis, the Y axis, and the Z axis are three axes perpendicular to one another. The X axis and the Y axis are axes parallel to a horizontal direction. The Z axis direction is a vertical direction. The head driver 14 includes a servomotor included in an operation mechanism for the movement of the processing head 10 in the X axis direction, a servomotor included in an operation equipment for the movement of the processing head 10 in the Y axis direction, and a servomotor included in an operation equipment for the movement of the processing head 10 in the Z axis direction. The head driver 14 is an operation equipment that enables translational motion in the direction of each of the three axes. FIG. 1 omits the illustration of the servomotors. The additive manufacturing apparatus 100 for metal additive manufactured products moves the processing head 10 by the head driver 14 and thus can move the irradiation position of the laser beam 21 on the workpiece. The additive manufacturing apparatus 100 for metal additive manufactured products may move the stage 15 to move the irradiation position of the laser beam 21 on the workpiece.

The processing head 10 illustrated in FIG. 1 causes the laser beam 24 to travel in the Z axis direction from the beam nozzle 11. The wire nozzle 12 is placed at a position away from the beam nozzle 11 in an XY plane, and advances the wire 5 in a direction that is at an angle with the Z axis. Note that the orientation in which the wire nozzle 12 is fixed in the machining head 10 may be changed so that the wire nozzle 12 advances the wire 5 in a direction parallel to the Z axis. The wire nozzle 12 is used to limit the advancement of the wire 5 such that the wire 5 is supplied to a desired position.

In the processing head 10 illustrated in FIG. 1, the gas nozzle 13 is placed coaxially with the beam nozzle 11 on an outer peripheral side of the beam nozzle 11 in the XY plane, and ejects gas along a central axis of the laser beam 24 emitted from the beam nozzle 11. That is, the beam nozzle 11 and the gas nozzle 13 are disposed coaxially with each other. Note that the gas nozzle 13 may eject the gas in a direction that is at an angle with the Z axis. That is, the gas nozzle 13 may eject the gas in a direction that is at an angle with the central axis of the laser beam 21 emitted from the beam nozzle 11.

A rotation mechanism 16 is an operation equipment that enables rotation of the stage 15 about a first axis and rotation of the stage 15 about a second axis perpendicular to the first axis. In the rotation mechanism 16 illustrated in FIG. 1, the first axis is an axis parallel to the X axis, and the second axis is an axis parallel to the Y axis. The rotation mechanism 16 includes a servomotor included in an operation equipment for rotating the stage 15 about the first axis, and a servomotor included in an operation equipment for rotating the stage 15 about the second axis. The rotation mechanism 16 is the operation equipment that enables rotational motion about each of the two axes. FIG. 1 omits the illustration of the servomotors. The additive manufacturing apparatus 100 for metal additive manufactured products rotates the stage 15 by the rotation mechanism 16 and thus can change a posture or position of the workpiece. That is, the additive manufacturing apparatus 100 for metal additive manufactured products rotates the stage 15 and thus can move the irradiation position of the laser beam 21 on the workpiece. When the rotation mechanism 16 is used, a complicated products having a tapered shape can be manufactured (or proceed).

Control means (hereinafter described as a control device 1) controls the additive manufacturing apparatus 100 for metal additive manufactured products in accordance with the processing program. The control device 1 controls the material supply unit 19, the irradiation unit, and the gas supply unit based on the oxidation temperature of the material measured in advance and the temperature obtained from the temperature measurement unit 9, and performs control for processing products without oxidization. The control for processing products without oxidization is to determine whether the temperature of the products is higher than or equal to the oxidation temperature by monitoring the temperature measured by the temperature measurement unit 9, and determine whether to continue the processing. As the control device 1, for example, a numerical controller is used.

The control device 1 outputs a move command to the head driver 14 to control driving of the head driver 14 and cause the processing head 10 to move. The control device 1 outputs a command corresponding to a condition of beam output to the laser oscillator 2, thereby controlling laser oscillation by the laser oscillator 2.

The control device 1 outputs a command corresponding to a condition of a feed of the material to the rotary motor 4, thereby controlling driving of the rotary motor 4. The control device 1 controls the driving of the rotary motor 4 to adjust the speed of the wire 5 from the wire spool 6 toward the irradiation position. In the following description, such a speed may be referred to as a feed rate. The feed rate represents the feed of the material per hour.

The control device 1 outputs a command corresponding to a condition of a feed of the gas to the gas supply device 7, thereby controlling the feed of the shielding gas 22 from the gas supply device 7 to the gas nozzle 13. The control device 1 outputs a rotation command to the rotation mechanism 16 to control driving of the rotation mechanism 16.

The control device 1 outputs a command corresponding to the temperature monitored at the time of processing to the laser oscillator 2, the head driver 14, the rotary motor 4, and the gas supply device 7, thereby controlling a processing parameter. That is, the control device 1 outputs various commands to control the entirety of the additive manufacturing apparatus 100.

The deposition 18 is formed by depositing a melted wire in the deposition region 23 using the laser beam 21 emitted from the beam nozzle 11. In the deposition region 23, as illustrated in FIG. 2, the wire 5 is supplied and irradiated with the laser beam 21, and the area around deposition is shielded from the atmosphere by the shielding gas 22. The temperature at anywhere point of the products is measured by the temperature measurement unit 9, so that the temperature at the time of processing is monitored and temperature information is sent to the control device 1.

The head driver 14 and the rotation mechanism 16 are operated in conjunction with each other to move the processing head 10 and the stage 15, so that the position of the deposition region 23 can be changed and the products having a desired shape can be obtained.

Here, a hardware configuration of the control device 1 will be described. The control device 1 illustrated in FIG. 1 is implemented when a control program, which is a program for executing control of the additive manufacturing apparatus 100 of the first embodiment, is executed by hardware.

Here, a hardware configuration of the control device 1 will be described. The control device 1 illustrated in FIG. 1 is implemented when a control program, which is a program for executing control of the additive manufacturing apparatus 100 of the first embodiment, is executed by hardware.

FIG. 3 is a block diagram illustrating the hardware configuration of the control device 1 according to the first embodiment of the present invention. The control device 1 includes a central processing unit (CPU) 41 that executes various processings, a random access memory (RAM) 42 including a data storage area, a read only memory (ROM) 43 that is a non-volatile memory, an external storage device 44, and an input/output interface 45 for inputting and outputting information to and from the control device 1. The components illustrated in FIG. 3 are connected to one another via a bus 46.

The CPU 41 executes programs stored in the ROM 43 and the external storage device 44. The control device 1 implements control of the entirety of the additive manufacturing apparatus 100 for metal additive manufactured products by using the CPU 41.

The external storage device 44 is a hard disk drive (HDD) or a solid state drive (SSD). The external storage device 44 stores the control program and various data. The ROM 43 stores software or a program for controlling hardware as a boot loader such as Basic Input/Output System (BIOS) or Unified Extensible Firmware Interface (UEFI) that is a program for basic control of a computer or a controller that is the control device 1. Note that the control program may be stored in the ROM 43.

The programs stored in the ROM 43 and the external storage device 44 are loaded into the RAM 42. The CPU 41 expands the control program in the RAM 42 and executes the various processings. The input/output interface 45 is a connection interface for connection with a device outside the control device 1. The input/output interface 45 receives the machining program. The input/output interface 45 also outputs various commands. The control device 1 may include an input device such as a keyboard and a pointing device, and an output device such as a display.

The control program may be stored in a computer-readable storage medium. The control device 1 may store, in the external storage device 44, the control program stored in the storage medium. The storage medium may be a portable storage medium that is a flexible disk, or may be a flash memory that is a semiconductor memory. The control program may be installed on the computer or controller serving as the control device 1 from another computer or server device via a communication network.

The control program may be stored in a computer-readable storage medium. The control device 1 may store, in the external storage device 44, the control program stored in the storage medium. The storage medium may be a portable storage medium that is a flexible disk, or may be a flash memory that is a semiconductor memory. The control program may be installed on the computer or controller serving as the control device 1 from another computer or server device via a communication network.

The functions of the control device 1 may be implemented by processing circuitry that is dedicated hardware for controlling the additive manufacturing apparatus 100 for metal additive manufactured products. The processing circuitry is a single circuit, a complex circuit, a programmed processor, a parallel-programmed processor, an application specific integrated circuit (ASIC), a field-programmable gate array (FPGA), or a combination thereof. The functions of the control device 1 may be implemented partly by the dedicated hardware and partly by software or firmware.

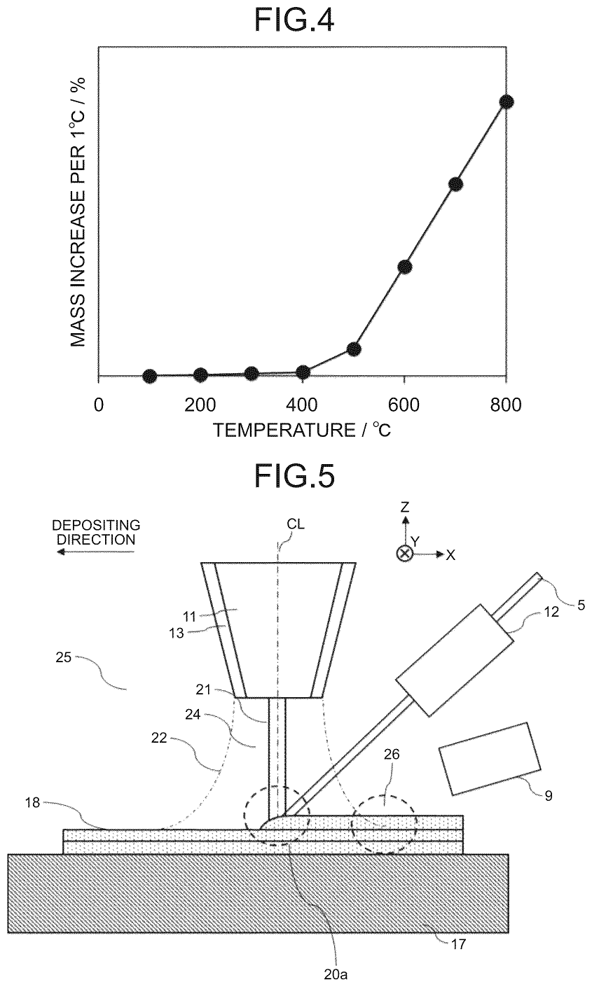

The operation of the additive manufacturing apparatus 100 for metal additive manufactured products according to the first embodiment will be described with reference to FIGS. 4 to 7. In the first embodiment, the temperature obtained from the temperature measurement unit 9, the information on the oxidation temperature of the material measured in advance, and the region shielded from the atmosphere by the shielding gas measured in advance are involved in the operation, and thus will be specifically described first.

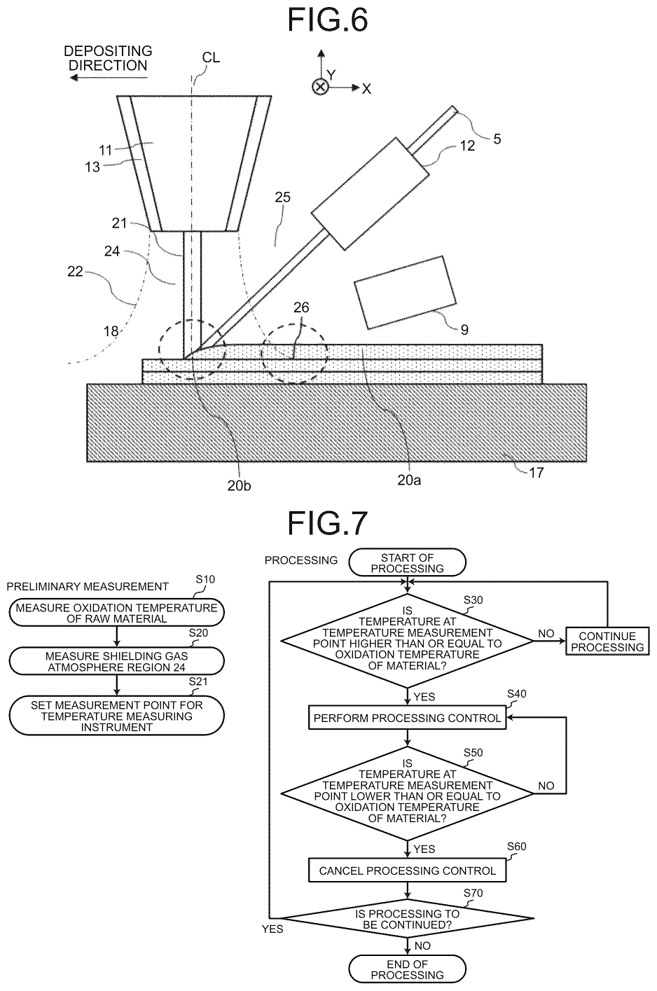

The oxidation temperature of the material is measured by a thermogravimetric/differential thermal analyzer. FIG. 4 is a schematic graph illustrating a mass change of a raw material whose temperature is increased in an air atmosphere by the thermogravimetric/differential thermal analyzer. For many metal materials, oxidation progresses by exposure to the atmosphere in a high temperature condition. Oxidation involves bonding of oxygen, which results in an increase in mass. The thermogravimetric/differential thermal analyzer can accurately quantify the mass change due to oxidation as increasing temperature, and can grasp the oxidation behavior of the raw material. FIG. 4 illustrates the mass increase of the material per 1° C., where there is a temperature at which oxidation progresses rapidly. Here, the temperature at which the mass increase occurs rapidly is defined as the oxidation temperature of the material, and is quantified as a temperature at which the mass increase per 1° C. is 1% or more as a guideline. Next, the temperature obtained from the temperature measurement unit 9 will be described. In principle of measurement of the device, any point can be measured, and it is necessary to choose a measurement region in which a measured temperature required for control is measured. Hereinafter, the measurement range for the temperature will be described in terms of oxidation of the material with reference to FIGS. 5 and 6.

FIGS. 5 and 6 are diagrams illustrating the deposition region of the additive manufacturing apparatus for metal additive manufactured products for explaining the temperature measurement range. FIG. 6 is the diagram illustrating a state after depositing has continued from the state in FIG. 5 and the processing head 10 has moved. A deposition point 20a is a position irradiated with the heat source. The products are formed by melting and depositing the material, and the temperature near the deposition point 20a is close to the melting point. The vicinity of the deposition point 20a is not oxidized due to a shielding gas atmosphere 24. However, as illustrated in FIG. 6, after the processing head 10 has moved, the deposition point 20a having high temperature is exposed to an air atmosphere 25 where the shielding gas does not reach, and oxidation progresses. Therefore, the range of the air atmosphere 25 where the shielding gas does not reach and the oxidation temperature of the material are parameters that determine whether or not the products are oxidized. That is, determining whether or not oxidation occurs requires information on the temperature at a boundary 26 that is in the air atmosphere after the shielding gas 22 emitted to the deposition point 20a has moved away from the vicinity of the deposition point 20a.

Here, the boundary 26 of a region that is in the air atmosphere 25 as the shielding gas 22 has moved away from the vicinity of the deposition point 20a can be estimated from an oxygen concentration measuring instrument. Then, a region where the oxygen concentration is 1% or lower is defined as a region 24 covered by the shielding gas. Therefore, the temperature measurement point to be monitored refers to the boundary 26 between the region 24 considered to be covered by the shielding gas and the region in the air atmosphere 25. The boundary 26 is measured in three dimensions, but, here, refers to an intersection with the products. The region in the shielding gas atmosphere subjected to oxygen concentration measurement needs to be measured before processing (or deposition). According to the principle described so far, the temperature measurement point is the boundary 26, but since oxidation can also be inhibited by performing measurement in the shielding gas atmosphere 25 inside the boundary 26, the measurement point may be an arbitrary point in a range between the deposition point 20a and the boundary 26.

FIG. 7 is a set of flowcharts for explaining the operation of the additive manufacturing apparatus for metal additive manufactured products. As illustrated in FIG. 7, the control device 1 is controlled by the flowcharts of preliminary measurement and processing. Measurement of the oxidation temperature of the material and the shielding gas atmosphere region as well as setting of the measurement point in the deposition region 23 are performed before processing, and a measured temperature value at the time of processing is compared with a temperature set on the basis of the oxidation temperature of the material, so that processing is controlled. The processing control refers to control selected from at least one of stopping processing to stop the movement of the machining head 10 and the laser irradiation, gradually reducing the output of processing, and slowing the speed of movement of the processing head 10.

That is, when the temperature at the measurement point during processing reaches the temperature set on the basis of the oxidation temperature of the material, the control device 1 performs at least one of the control of stopping the output of the heat source with which the deposition region 23 is irradiated, the control of reducing the output, or the control of reducing the speed of movement or stopping the movement of the heat source moving in the deposition region 23. Here, temperature measurement is performed such that the temperature does not exceed the oxidation temperature in the air atmosphere 25, and when the temperature is detected to have exceeded the oxidation temperature, processing parameter control is performed to prevent heat storage of products. Then, upon confirmation that the processing temperature is lower than or equal to the oxidation temperature of the material, processing is resumed or the processing parameter is changed.

The preliminary measurement includes step S10 of measuring the oxidation temperature of the raw material, step S20 of measuring the shielding gas atmosphere region 24, and step S21 of setting the temperature measurement point from step S20. Here, S10 and S20 may be performed in any order.

The deposition process includes a step of supplying the material of metal additive manufactured products to the deposition region 23, a step of irradiating the deposition region 23 with the heat source that melts the material, and a step of ejecting the shielding gas to the deposition region 23.

As processing, the present embodiment performs step S30 of deposition while monitoring the temperature at the temperature measurement point from the start of processing and determining whether the temperature at the measurement point is higher than or equal to the oxidation temperature of the material. At the start of processing, heat storage is not accumulated in the products in many cases. In this case, the temperature is lower than or equal to the oxidation temperature of the material set in advance, so that no control is necessary and the process returns to step S30.

Then, as processing is continued, the measured temperature increases to the oxidation temperature. When the measured temperature exceeds the oxidation temperature, the process proceeds to step S40. With the measured temperature exceeding the oxidation temperature, in step S40, the processing parameter is changed or deposition is stopped, and the process proceeds to step S50.

Next, in step S50, if the temperature at the temperature measurement point is higher than or equal to the oxidation temperature of the material, the control continues to be performed, and upon confirmation that the temperature is lower than or equal to the oxidation temperature, the process proceeds to step S60 of canceling the processing control such as determining that deposition can be performed and resuming deposition. When deposition is resumed, the processing parameter and the like may be changed. Processing is stopped for a moment in the control method described herein, but need not always be stopped. For example, if heat storage can be reduced by changing the output, processing need not always be stopped. A determination is made as to whether processing is completed in stage S70, and if processing is to be continued, the process returns to step S30 of performing the temperature measurement point, and processing is performed in a similar flow. If processing is completed, processing is ended.

As described above, the additive manufacturing apparatus 100 for metal additive manufactured products according to the present embodiment includes the material supply unit 19 that supplies the material of metal additive manufactured products to the deposition region 23, the irradiation unit that irradiates the deposition region 23 with the heat source that melts the material, and the gas supply unit that ejects the shielding gas to the deposition region 23. The additive manufacturing apparatus 100 also includes the temperature measurement unit 9 that measures the temperature at the measurement point in the deposition region 23, and the control device 1 that performs at least one of the control of stopping the output of the heat source with which the deposition region 23 is irradiated, the control of reducing the output, or the control of reducing the speed of movement or stopping the movement of the heat source moving in the deposition region, when the temperature at the measurement point during processing reaches the temperature set on the basis of the oxidation temperature of the material.

When the additive manufacturing apparatus 100 for metal additive manufactured products as described above is used, the products that are not oxidized can be manufactured without exposure to the air atmosphere 25 when the temperature is higher than or equal to the oxidation temperature.

Moreover, an additive manufacturing method for metal additive manufactured products according to the present embodiment includes the step of supplying the material of metal additive manufactured products to the deposition region 23, the step of irradiating the deposition region 23 with the heat source that melts the material, and the step of ejecting the shielding gas to the deposition region 23. The manufacturing method also measures the temperature at the measurement point in the deposition region, and performs at least one of the control of stopping the output of the heat source with which the deposition region 23 is irradiated, the control of reducing the output, or the control of reducing the speed of movement or stopping the movement of the heat source moving in the deposition region, when the temperature at the measurement point during processing reaches the temperature set on the basis of the oxidation temperature of the material.

By the manufacturing method for metal additive manufactured products as described above, the products that are not oxidized can be manufactured without exposure to the air atmosphere 25 when the temperature is higher than or equal to the oxidation temperature. As a result, without being affected by the sense that it may be better to stop processing as heat is accumulated, processing can be controlled theoretically on the basis of the relationship between the oxidation temperature and the measured temperature, and the products that is not oxidized regardless of shape and material can be manufactured.

Note that in the description of the principle of measurement heretofore, the temperature at which oxidation progresses rapidly has been defined as the oxidation temperature, but in a case where the amount of oxidation in the products is to be further reduced, a desired effect can be obtained as long as the target temperature is an arbitrary temperature lower than or equal to the oxidation temperature. Hereinafter, specific cases will be described.

### First Example

Here, a titanium alloy (Ti-6Al-4V) that is easily oxidized will be described. The titanium alloy is used because oxidation thereof is apparent, but another metal material other than the titanium alloy may be used as long as the principle of the present invention is used. For example, a Ni-based alloy, an Fe-based alloy, and an Al-based alloy often used for a metal additive manufactured products may be used, but another metal may be used as well.

As a preliminary experiment before processing, a predetermined amount of powder of the titanium alloy was measured, and a mass change thereof was measured by a thermogravimetric/differential thermal balance. The alloy in the form of powder is desirably used in the present measurement, but the alloy in the form of wire may be used.

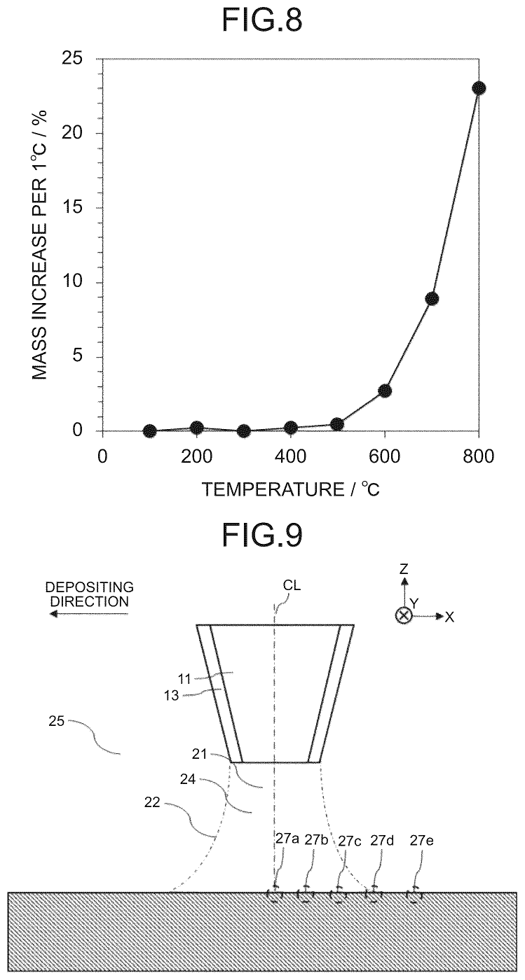

Here, the rate of temperature increase is set to 10° C./min but is not limited thereto as the rate does not affect the oxidation temperature. FIG. 8 illustrates the temperature and the mass change at the time of the temperature increase. Here, the mass change means that the titanium alloy reacts with oxygen in the atmosphere to be oxidized, thereby increasing in mass. Whether the oxide phase is desired can be determined by measurement with an X-ray analyzer. From data on the mass change thus obtained, the temperature at which the mass increase per 1° C. is 1% or more is defined as the oxidation temperature of the material. Performing this preliminary experiment allows for estimation of the oxidation temperature of each material type. As a result of the experiment, the oxidation temperature of the titanium alloy was estimated to be 510° C.

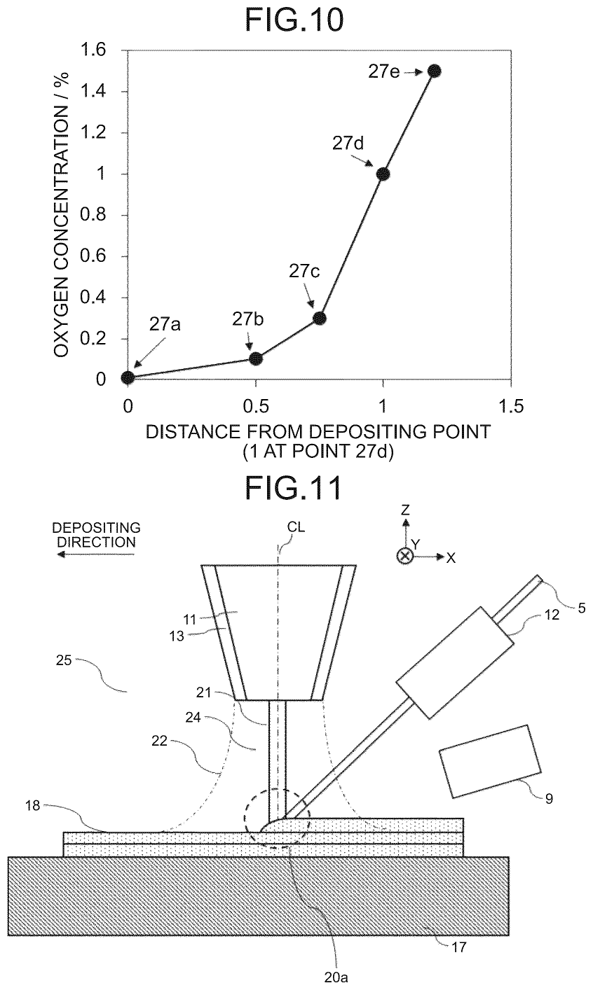

Next, the shielding gas atmosphere region 24 shielded from the atmosphere is roughly estimated with reference to FIGS. 9 and 10. FIG. 9 is a diagram illustrating points (27a to 27e) measured by an oximeter, and FIG. 10 is a result of measurement of the oxygen concentration at the measurement points in FIG. 9. The processing head 10 is fixed without the laser beam being emitted. At this time, the shielding gas 22 is emitted. The shielding gas is discharged at an arbitrary rate, which may be freely changed by an operator. Next, the oximeter is disposed directly below the processing head 10 and measures the oxygen concentration. Next, the processing head 10 or the oximeter is displaced so that the oximeter is gradually separated from the processing head 10 and performs measurement at the points 27a to 27e. At this time, it is assumed that the processing head 10 is displaced in a direction along the X-Y axis plane in which processing is to be performed. As the processing head 10 and the oximeter are gradually separated, the oximeter goes out of reach of the shielding gas, and the oxygen concentration gradually increases. A distance at a point where the oxygen concentration reaches 1% or more corresponds to the point 27d. That is, it can be said that the range including the points 27a to 27d away from the processing deposition point is in the environment where oxidation does not readily occur due to the shielding gas. The temperature measurement point may be any point covered under the shielding gas atmosphere 24. Here, the boundary 26 with the shielding gas atmosphere is set as the measurement point.

Next, the additive manufacturing apparatus 100 for metal additive manufactured products is used to perform deposition. First, various installation will be described. The substrate 17 is mounted on the stage 15. The wire 5 is attached to the rotary motor 4 and brought close to the substrate 17 through the wire nozzle. At this time, the wire may or need not be in contact with the substrate 17. A radiation thermometer is installed coaxially with the machining head 10 to perform measurement on the measurement point 26. As a result, when the processing head 10 moves, the radiation thermometer moves following the processing head 10 and can always perform measurement on the measurement point from the machining point. This setting method is an example, and, as another example, a method may be used in which a standalone thermoviewer is installed and selects the measurement point on the thermoviewer. Although there is a case of moving the stage and not moving the processing head 10, it is sufficient if the installation is done to allow similar measurement on the temperature measurement point 26 from the deposition point.

The wire raw material, the substrate 17, and the temperature measurement unit 9 are installed, oxidation temperature data is acquired in advance, and when the temperature is successfully measured, processing is started. A tip of the wire is melted with predetermined laser output, feed of the wire, and axial speed, and the melted liquid is deposited. Here, although the main parameters are described, there are also parameters regarding a beam diameter and laser oscillation related thereto.

From the start to the early stage of processing, the temperature at the measurement point 27d was about 300° C., from which one can determine that oxidation has not progressed, whereby processing was continued on the basis of step S30. The temperature increased as processing was continued, and exceeded the oxidation temperature of 510° C. at a certain point. Here, on the basis of step S40, the movement of the machining head 10 was stopped, and the oscillation of the laser was also stopped. The process proceeded to step S50, and a gradual decrease in the measured temperature was confirmed. Processing may be resumed at any time when the temperature is below the oxidation temperature of 510° C., such as immediately after the temperature has fallen below 510° C. or after confirmation that the temperature has dropped to 300° C. or 100° C. Processing may be started at any temperature lower than or equal to the oxidation temperature. Next, when the temperature has fallen below a predetermined temperature, the process proceeds to step S60 and resumes processing. At this time, the parameter of processing may be changed. After that, processing was continued similarly on the basis of S30 to S70 while observing the temperature, and the products was manufactured.

An amount of oxygen in the products obtained was measured by an infrared absorption method. The method of measuring the amount of oxygen in the products is not limited to this method. A standard for the amount of oxygen in the titanium alloy is set to 0.2 wt % or less, and the amount of oxygen in the products was confirmed to be less than or equal to 0.2 wt % and was found to satisfy the standard.

### First Comparative Example

In a first comparative example, in order to verify an effect of the control based on the oxidation temperature and the temperature measurement, processing was continued without performing the control. That is, processing was continuously performed with the initial parameters at the start of processing. Regarding the installation before processing, preparation was performed similarly to that in the first example. Processing was carried out without being stopped at the timing when the control was started in the first example. For comparison, the temperature at the time of processing was measured to be 800° C. or higher which is beyond 510° C. Since the temperature exceeds the oxidation temperature of the titanium alloy, one can easily estimate that oxidation progresses. An actual measurement of the amount of oxygen exceeded the standard of 0.2 wt %.

### Second Comparative Example

In a second comparative example, the shielding gas atmosphere region 24 mentioned in the first example was examined. In the second comparative example, a range where the oxygen concentration is 1.5% or lower was defined as the shielding gas atmosphere region 24. Since the measured oxygen concentration increases as the distance from the deposition point increases, the range where the oxygen concentration is 1.58 or lower corresponds to the point 27e in FIG. 9. That is, the point indicates a position farther from the deposition point than the corresponding point in the first example. This time, the temperature was measured at an arbitrary point where the oxygen concentration is higher than 1.0% and 1.58 or lower (a range between the points 27d and 27e).

The installation was performed similarly to that in the first example, and processing was started. From the start of processing to the early stage of processing, the temperature at the measurement point 27e was about 250° C., from which one can determine that oxidation has not progressed, whereby processing was continued on the basis of step S30. Since the measurement point was farther from the disposition point than that in the first example, the temperature measured was lower than that in the first example but gradually approached 510° C. and exceeded the oxidation temperature of 510° C. Here, on the basis of step S40, the movement of the machining head 10 was stopped, and the oscillation of the laser was also stopped. The process proceeded to step S50, and a gradual decrease in the measured temperature was confirmed. Processing may be resumed at any time when the temperature is below the oxidation temperature of 510° C., such as immediately after the temperature has fallen below 510° C. or after confirmation that the temperature has dropped to 300° C. or 100° C. Processing may be started at any temperature lower than or equal to the oxidation temperature. Next, when the temperature has fallen below a predetermined temperature, the process proceeds to step S60 and resumes processing. At this time, the parameter of processing may be changed. After that, processing was continued similarly on the basis of S30 to S70 while observing the temperature, and the products was manufactured.

A measurement of the amount of oxygen in the products obtained exceeded the standard of 0.2 wt %, as has been the case so far. Because amount of oxidation in products is exceeded standard, the products was determined to be unsatisfactory.

From the above, one can estimate that the point where the oxygen concentration is 1.0 wt % or lower as the shielding gas atmosphere region 24 is effective in determining oxidation of the products.

### Third Comparative Example

So far in the first example, the oxidation temperature has been set to 510° C. At this temperature, the mass increase per 1° C. is 1% or more. In a third comparative example, the temperature set as the oxidation temperature was examined. For comparison and verification, in the third comparative example, the oxidation temperature was set to 580° C. at which the mass increase per 1° C. is 2% or more.

The installation was performed similarly to that in the first example, and processing was started. From the start of processing to the early stage of processing, the temperature at the measurement point 27d was about 300° C., from which one can determine that oxidation has not progressed, whereby processing was continued on the basis of step S30. As processing was continued, the temperature at the measurement point increased and exceeded 510° C. that is the oxidation temperature in the first example. In the present third comparative example, 510° C. is lower than or equal to the oxidation temperature, so that processing was continued without control until the temperature exceeded 580° C. Processing was further continued, and when the temperature reached 580° C., the process proceeded to step S40 on the basis of step S30. Here, on the basis of step S40, the movement of the machining head 10 was stopped, and the oscillation of the laser was also stopped. The process proceeded to step S50, and a gradual decrease in the measured temperature was confirmed. Processing may be resumed at any time when the temperature is below the oxidation temperature of 580° C., such as immediately after the temperature has fallen below 580° C. or after confirmation that the temperature has dropped to 300° C. or 100° C. Processing may be started at any temperature lower than or equal to the oxidation temperature. Next, when the temperature has fallen below a predetermined temperature, the process proceeds to step S60 and resumes processing. At this time, the parameter of processing may be changed. After that, processing was continued similarly on the basis of S30 to S70 while observing the temperature, and the products were manufactured.

A measurement of the amount of oxygen in the products obtained exceeded the standard of 0.2 wt %, as has been the case so far. Not complying with the standard, the deposition was determined to be unsatisfactory.

The above result has led to the conclusion that, when the oxidation temperature is set to the temperature at which the mass increase per 1° C. is 2 wt % or more, the products is oxidized. Therefore, it is considered appropriate to set the oxidation temperature to the temperature at which the mass increase per 1° C. is 1 wt % or more.

### Second to Fifth Examples

In the present second to fifth examples, passes at the time of processing will be described with reference to FIGS. 11 to 14. In a typical method of manufacturing a metal additive manufactured products in which a raw material is melted and deposited, as illustrated in FIG. 11, processing is continuously performed on the base material 17 and the products according to a predetermined pass. For example, in a case where a thin plate shape having a width of 50 mm is to be deposited, a bead that is formed while supplying the laser and the wire to the base material 17 and depositing the wire thereon is drawn by 50 mm in one go, and another layer of bead is deposited so as to be stacked on the deposited bead. As has been described, the method of continuously melting and depositing the raw material is often adopted. Such a deposition pass for continuous bead formation is referred to as a line bead pass. The second example describes deposition using the line bead. The control performed in the first example was attempted using the line bead. The temperature increase is noticeable as processing is continuously performed, but oxidation was successfully controlled by the control of the present invention. From a result of measurement of the amount of oxygen, it was confirmed that oxidation did not occur in the present processing.

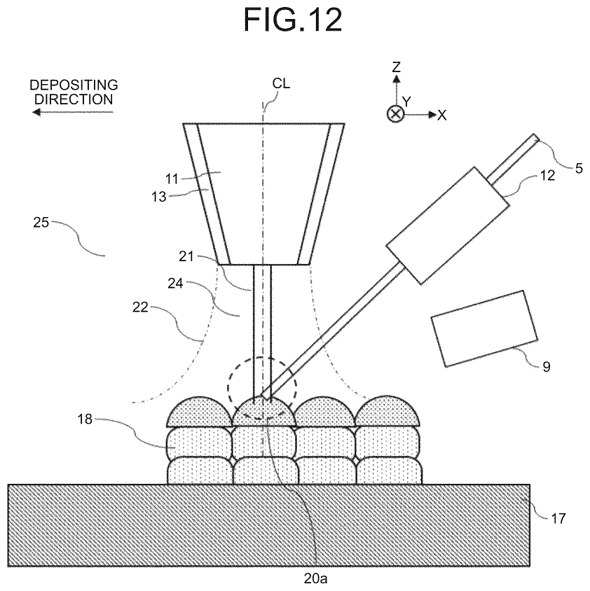

Next, in the third example, instead of the line bead pass for continuously performing depositing, a method was adopted as illustrated in FIG. 12 in which the wire melted by irradiating the wire with the laser is dropped onto the substrate 17 or the products, and then the wire is withdrawn for a moment, moved to an adjacent depositing spot, and melted and dropped again. The wire is not irradiated with the laser after being dropped at one point until being moved to the next point and is dropped one drop at a time like a ball, and thus such a depositing pass is referred to as a ball-shaped bead pass. The control performed in the first example was attempted using the present depositing pass. Since depositing is performed one point at a time, heat is accumulated less compared to the case of the line bead, but it was confirmed that the temperature exceeds 510° C., which is the oxidation temperature, when depositing was performed for a long time or when depositing from which heat storage is less easily removed was performed. Therefore, the control as described in the first example was performed to form the depositing. From a result of measurement of the amount of oxygen, it was confirmed that oxidation did not occur in the present depositing.

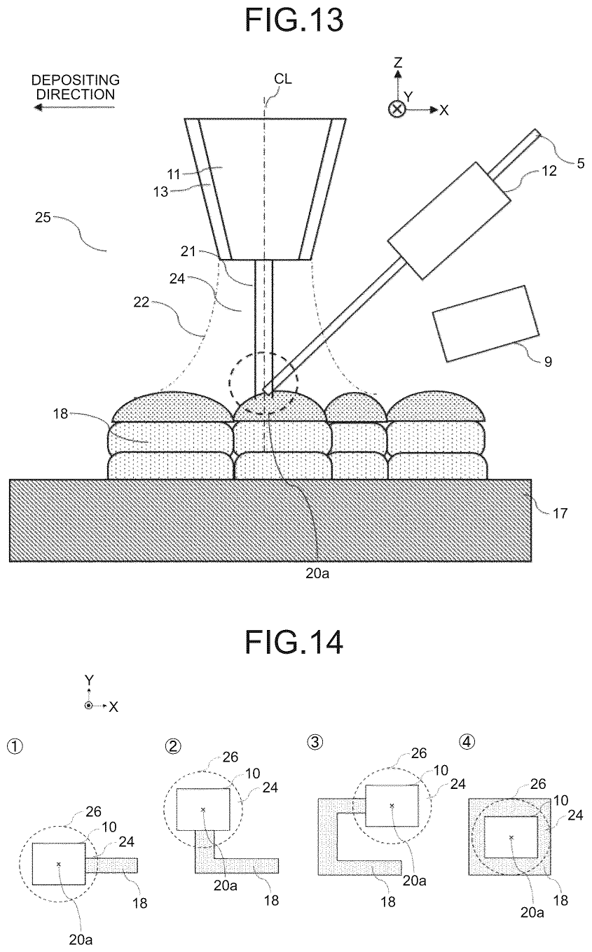

Next, the fourth example describes a depositing pass called a segment bead depositing pass. The segment bead depositing pass is a combination of the depositing passes of the second and third examples, and is the depositing pass illustrated in FIG. 13. In a method using the segment bead depositing pass, the bead deposited by irradiation with the laser as with the line bead is stopped at an arbitrary length, the wire is moved to the next point as with the ball-shaped bead, and the line bead is drawn again. That is, the wire as the material is melted by irradiation with the heat source to be dropped and continuously deposited in the deposition region, then the wire is withdrawn for a moment, moved, and melted again to be dropped and deposited.

The bead length of the line bead illustrated here can be set to any length. In addition, the line bead need not always be formed after the ball-shaped bead, and the ball-shaped bead may be continuously formed a plurality of times. Such a combination of the line bead pass and the ball-shaped bead pass results in a bead like a segment in the depositing pass, and is thus referred to as a segment bead pass. The control performed in the first example was attempted using the present segment depositing pass. As with the second and third examples, it was confirmed that the temperature exceeded the oxidation temperature of 510° C. as depositing was continued. Therefore, the control as described in the first example was performed to form the depositing. From a result of measurement of the amount of oxygen, it was confirmed that oxidation did not occur in the present depositing.

Next, the fifth example describes a fill pass. For the sake of simplicity, the description so far has been made on the basis of the schematic views in which depositing is performed in the X axis direction, but in depositing a large area, the machining head 10 does not necessarily have to be moved in one direction limited to the X axis or the Y axis, and it is more effective when the machining head 10 is freely moved in the XY plane. A method is used in which depositing is performed while freely moving the machining head 10 in the XY plane using the depositing passes of the second to fourth examples. That is, the wire as the material is melted by irradiation with the heat source, and is dropped while moving in an arbitrary direction within a plane of the deposition region. An example will be described with reference to FIG. 14. A pass is formed in which the machining head 10 swept along the X axis is swept in the Y axis direction and swept again along the X axis to fill the inside. In the case of such a pass, it is necessary to perform measurement on, as the measurement point, a point concentric with the boundary 26 between the shielding gas atmosphere and the air atmosphere. In this case, the temperature measurement unit 9 as a standalone unit may be placed near the processing apparatus 100 to measure a plurality of points on the boundary 26. The control flow is similar to that of the first example. From a result of measurement of the amount of oxygen in the products formed, it was confirmed that oxidation did not occur in the present depositing. As described above, the depositing pass using the control of the present invention can realize depositing without oxidation.

### Second Embodiment

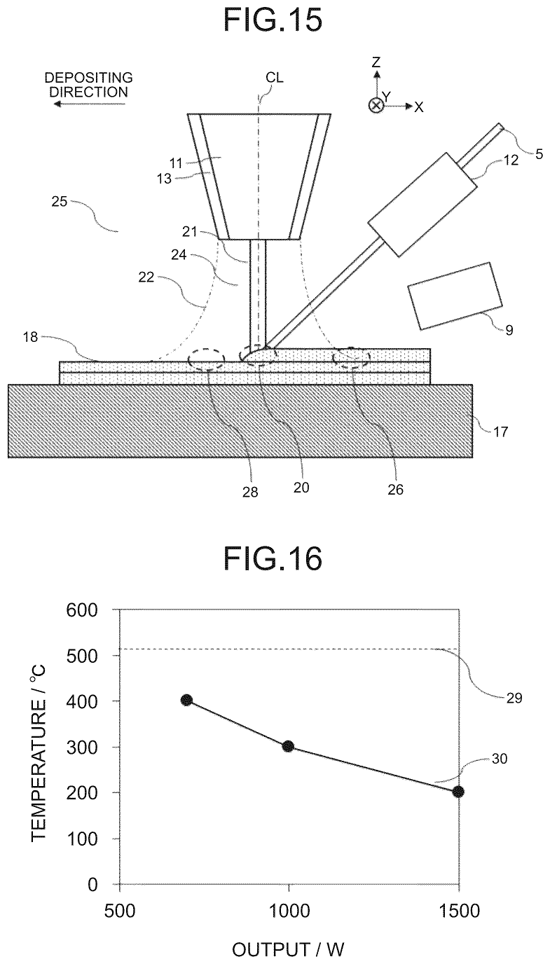

The first embodiment has theoretically described whether or not oxidation occurs on the basis of the oxidation temperature and the temperature at the boundary 26 between the shielding gas atmosphere and the air atmosphere. Using the aforementioned principles, a second embodiment will describe a mode of an additive manufacturing apparatus for metal additive manufactured products that measures the temperature more simply. Hereinafter, the effectiveness of an interpass temperature will be described with reference to FIGS. 15 and 16.

FIG. 15 illustrates a temperature measurement point in the second embodiment of the present invention. In the second embodiment, the temperature measurement unit 9 measures the temperature of the workpiece. That is, the temperature measurement unit 9 measures the temperature of the products to be the base before the substrate 17 or the material is stacked. Hereinafter, the temperature obtained from the products is referred to as the interpass temperature. The interpass temperature is a generic term for a temperature at a certain point on the products before being deposited, and may be a temperature near the depositing point or a temperature far from the depositing point. The measurement point is, for example, a position that is closer to the position irradiated with the heat source than the boundary between the shielding gas atmosphere by the shielding gas and the air atmosphere is.

The second embodiment measures the interpass temperature to control the additive manufacturing apparatus 100 for metal additive manufactured products. When the interpass temperature is used for control, the correspondence between the oxidation temperature of the material used in the first embodiment and the interpass temperature is required. That is, the interpass temperature of the shaped object whose temperature is higher than or equal to the oxidation temperature in the first embodiment is measured so that the relationship between the oxidation temperature and the interpass temperature is established. The state of the products whose temperature is higher than or equal to the oxidation temperature is indirectly measured by the interpass temperature, so that whether oxidation occurs or not can be indirectly controlled without necessarily measuring the temperature at the boundary 26 between the shielding gas atmosphere and the air atmosphere.

FIG. 16 illustrates a schematic graph of the relationship of the interpass temperature when the temperature at the boundary 26 between the shielding gas atmosphere and the air atmosphere reaches an oxidation temperature 29 at the time the shaped object is shaped at a plurality of laser outputs using the additive manufacturing apparatus 100 for metal additive manufactured products. Since the heat input to the products increases as the laser output increases, in a case where an index of the temperature of the products after the heat input is set to the oxidation temperature 29, an interpass temperature 30 that is the temperature of the products before the heat input is lower, as illustrated in the graph. Accordingly, the interpass temperature 30 when the temperature at the boundary 26 between the shielding gas atmosphere and the air atmosphere reaches the oxidation temperature 29 is known for each laser output, and with the interpass temperature 30, the additive manufacturing apparatus 100 for metal additive manufactured products can be controlled.

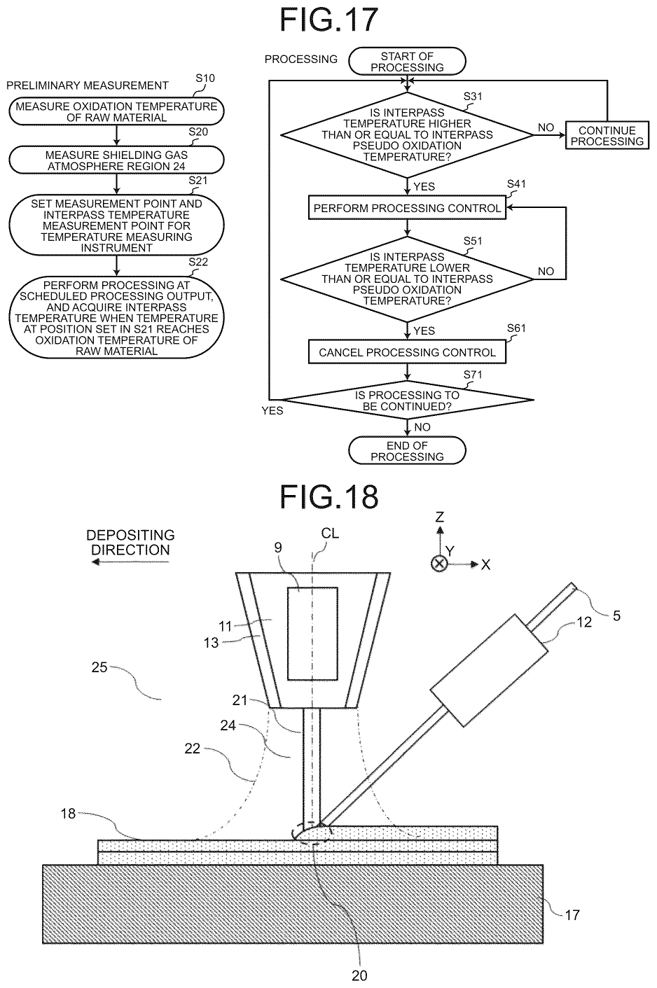

Next, a description will be made of pre-measurement for the control using the interpass temperature and an operation of the additive manufacturing apparatus 100 for metal additive manufactured products in the second embodiment. FIG. 17 is a set of flowcharts for explaining the operation of the additive manufacturing apparatus 100 for metal additive manufactured products in the second embodiment of the present invention. The flowcharts include two parts that are pre-measurement and processing of metal additive manufactured products.

First, in step S10, a thermogravimetric/differential thermal analysis is performed to calculate the oxidation temperature of the raw material at which the mass increase per 1° C. is 1% or more. Next, in step S20, an oximeter is used to measure the boundary between the shielding gas atmosphere and the air atmosphere. Next, in step S21, the temperature measurement unit 9 is placed to be able to measure the temperatures at the boundary and near the depositing point.

Next, as pre-processing in step S22, processing is performed at a target output in the present processing. The interpass temperature when the temperature at the boundary exceeds the oxidation temperature of the material is measured. In a case where the output may be changed in the present processing, the interpass temperature is measured similarly by changing the output. The interpass temperature thus obtained when the temperature at the boundary between the shielding gas atmosphere and the air atmosphere exceeds the oxidation temperature is referred to as an interpass pseudo oxidation temperature. The pre-measurement is thus completed.

Next, the additive manufacturing apparatus 100 for metal additive manufactured products is controlled to perform processing. Processing is performed on the basis of the control device 1, the processing head 10, the laser oscillator 2, the rotation mechanism 16, and the pre-measurement result described in the first embodiment.

Processing is performed in step S31 while monitoring the interpass temperature from the start of processing and determining whether the temperature at the measurement point is higher than or equal to the interpass pseudo oxidation temperature of the material. At the start of processing, heat is not accumulated in the products in many cases. In this case, the temperature is lower than or equal to the interpass pseudo oxidation temperature of the material set in advance, so that no control is necessary and the process returns to step S31.

Then, as processing is continued, the interpass temperature gets close to the interpass pseudo oxidation temperature. When the interpass temperature exceeds the interpass pseudo oxidation temperature, the process proceeds to step S41. In step S41, with the interpass temperature exceeding the interpass pseudo oxidation temperature, the processing parameter is changed or processing is stopped, and the process proceeds to step S51. Processing control refers to control selected from at least one of stopping processing to stop the movement of the processing head 10 and the laser irradiation, gradually reducing the output of processing, and slowing the speed of movement of the processing head 10. That is, when the temperature at the measurement point during processing reaches the temperature set on the basis of the oxidation temperature of the material, the control device 1 performs at least one of the control of stopping the output of the heat source with which the deposition region 23 is irradiated, the control of reducing the output, or the control of reducing the speed of movement or stopping the movement of the heat source moving in the deposition region 23.

Next, in step S51, if the interpass temperature is higher than or equal to the interpass pseudo oxidation temperature of the material, the control continues to be performed, and upon confirmation that the interpass temperature is lower than or equal to the interpass pseudo oxidation temperature, the process proceeds to step S61 of canceling the processing control such as determining that processing can be performed and resuming processing. When processing is resumed, the processing parameter and the like may be changed. Processing is stopped for a moment in the control method described herein, but need not always be stopped. For example, if heat accumulation can be reduced by changing the output that is the parameter affecting heat accumulation, processing need not always be stopped. A determination is made as to whether processing is completed in stage S71, and if processing is to be continued, the process returns to step S31 of performing the temperature measurement point, and processing is performed in a similar flow. If processing is completed, processing is ended.

By repetition of such control and indirect management by the interpass temperature, it is possible to manufacture the products that is not oxidized without exposure to the region where the shielding gas does not reach when the temperature is higher than or equal to the oxidation temperature.

Hereinafter, with a specific case, the control using the interpass temperature will be described.

### Sixth Example

Here, the titanium alloy (Ti-6Al-4V) that is easily oxidized will be described. The titanium alloy is used because oxidation thereof is apparent, but another metal material other than the titanium alloy may be used as long as the principle of the present invention is used.

As preliminary measurement before processing, steps S10 and S20 to S22 of estimating the oxidation temperature of the titanium alloy and the region shielded from the atmosphere by the shielding gas were performed similarly to those in the first example. According to the first example, the oxidation temperature of the titanium alloy is 510° C., and the range of the shielding gas corresponds to the region where the oxygen concentration is 18 or lower.

Next, in step S31, the correlation between the interpass temperature and the measured temperature at the boundary between the shielding gas atmosphere and the air atmosphere was acquired. The interpass temperature is a temperature obtained by installing a radiation thermometer coaxially with the processing head 10 and performing measurement at a point that is 5 mm from the deposition point in a direction of travel of the processing head 10. This setting method is an example, and, as another example, a method may be used in which a standalone thermoviewer is installed and selects the measurement point on the thermoviewer. In addition, an environment in which the temperature at the boundary between the shielding gas atmosphere and the air atmosphere can be measured was constructed with reference to the first example.

As an experiment for acquiring the prior correlation, for example, in a case where the experiment was conducted at 1000 W output, the interpass temperature was about 300° C. when the measured temperature at an edge of the range covered by the shielding gas exceeded 510° C. The correlation was similarly acquired in a case of 1500 W output, at which the interpass temperature was about 200° C., and a predetermined temperature of the interpass temperature for a certain output was calculated.

Next, the additive manufacturing apparatus 100 for metal additive manufactured products is used to perform processing. First, various installation will be described. The substrate 17 is mounted on the stage 15. The wire 5 is attached to the rotary motor 4 and brought close to the substrate 17 through the wire nozzle. At this time, the wire 5 may or need not be in contact with the substrate 17. When the raw material of the wire, the substrate 17, and the temperature measurement unit 9 have been installed and the interpass temperature can be measured, processing is started while actually performing control. A tip of the wire is melted with predetermined laser output, feed of the wire, and axial speed, and the melted liquid is deposited. Here, although the main parameters are described, there are also parameters regarding a beam diameter and laser oscillation related thereto.

Here, a case where processing was performed at 1000 W will be described. From the start of processing to the early stage of processing, the interpass temperature was about 80° C., which is lower than or equal to the interpass pseudo oxidation temperature and from which one can determine that oxidation has not progressed, whereby processing was continued according to step S31. The temperature increased as processing was continued, and the interpass temperature exceeded the interpass pseudo oxidation temperature at a certain point. When the interpass temperature exceeded the interpass pseudo oxidation temperature, the process proceeded to step S41 to stop processing, stop the movement of the processing head 10, and stop the oscillation of the laser. The process proceeded to step S51, and a gradual decrease in the measured temperature was confirmed.

Processing may be resumed at any time when the temperature is below the interpass pseudo oxidation temperature, such as immediately after the temperature has fallen below the interpass pseudo oxidation temperature or after confirmation that the temperature has dropped sufficiently. Processing may be started at any temperature lower than or equal to the interpass pseudo oxidation temperature estimated from the pre-measurement.

Next, when the temperature has fallen below a predetermined temperature, the process proceeds to step S61 and resumes processing. At this time, the parameter of processing may be changed. Similarly, processing was performed while performing temperature measurement and paying attention that the temperature did not become higher than or equal to the interpass pseudo oxidation temperature, and when the temperature exceeded the interpass pseudo oxidation temperature, processing was stopped and then resumed in step S71 after confirmation that the temperature dropped, whereby the products was formed while performing similar control. Although the case of not changing the parameter has been described, for example, the output may be changed to 1000 W in the control since the interpass pseudo oxidation temperature exceeded 200° C. at the first output of 1500 W. In the case of changing the output to 1000 W, the interpass pseudo oxidation temperature is 300° C., whereby the temperature determined by the control is changed.

An amount of oxygen in the products obtained was measured by the infrared absorption method. The standard for the amount of oxygen in the titanium alloy is set to 0.2 wt % or less, and the amount of oxygen in the products was confirmed to be less than or equal to 0.2 wt % and was found to satisfy the standard.

### Third Embodiment

The first and second embodiments have theoretically mentioned whether or not oxidation occurs from the oxidation temperature and the temperature at the boundary 26 between the shielding gas atmosphere and the air atmosphere, and have described the interpass temperature as a simpler method. A third embodiment will describe, as an alternative method, a mode of an additive manufacturing apparatus for metal additive manufactured products that performs control from the temperature at the deposition point. Hereinafter, the effectiveness of the temperature at the deposition point will be described with reference to FIG. 18.

FIG. 18 illustrates a temperature measurement point in the third embodiment of the present invention. In the third embodiment, the temperature measurement unit 9 measures the temperature of the products being deposited that is formed by melting the material, the measurement point is a deposition point 20 that is a position irradiated with the heat source, and the temperature obtained from the deposition point is referred to as a deposition point temperature. Since the measurement point coincides with the deposition point, the temperature measurement unit 9 is placed coaxially with the processing head 10. As a result, a temperature history can be reliably obtained even when the processing head 10 moves in a complicated manner.

The third embodiment measures the deposition point temperature to control the additive manufacturing apparatus 100 for metal additive manufactured products. When the deposition point temperature is used for control, the correspondence between the oxidation temperature of the material used in the first embodiment and the deposition point temperature is required. That is, the deposition point temperature of the products whose temperature is higher than or equal to the oxidation temperature in the first embodiment is measured so that the relationship between the oxidation temperature and the deposition point temperature is established. The state of the products whose temperature is higher than or equal to the oxidation temperature is indirectly measured by the deposition point temperature, so that whether oxidation occurs or not can be indirectly controlled without necessarily measuring the temperature at the boundary 26 between the shielding gas atmosphere and the air atmosphere.

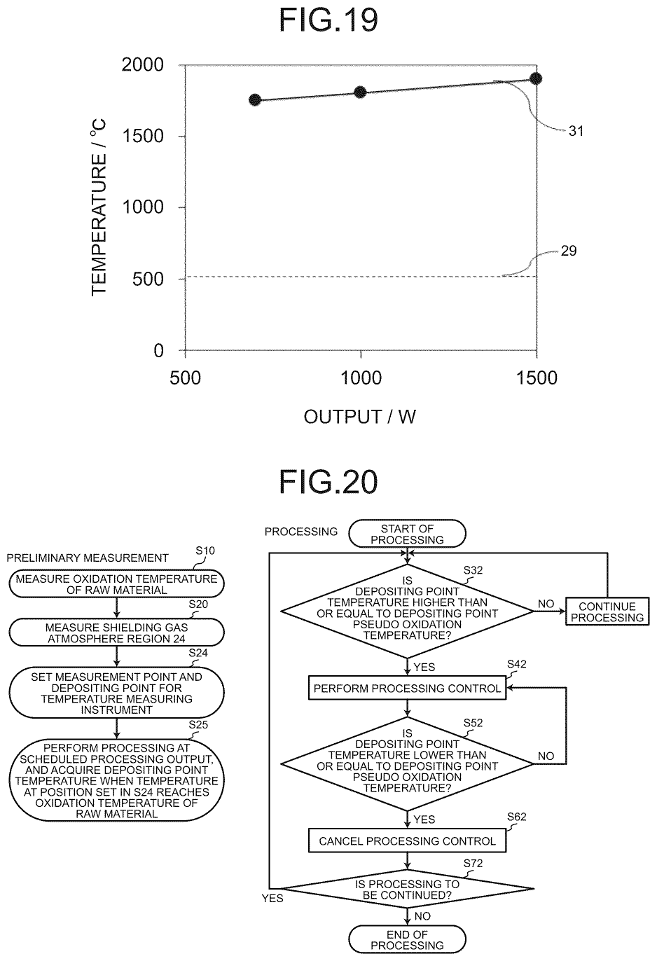

FIG. 19 illustrates a schematic graph of the relationship between the oxidation temperature 29 and a deposition point temperature 31 using the additive manufacturing apparatus 100 for metal additive manufactured products. The deposition point temperature 31 is a temperature at the position immediately above where depositing takes place and is generally higher than the oxidation temperature, but it can be seen that as the laser output increases, the deposition point temperature 31 increases. Accordingly, the deposition point temperature 31 when the temperature at the boundary 26 between the shielding gas atmosphere and the air atmosphere reaches the oxidation temperature 29 is known, and with the deposition point temperature 31, the additive manufacturing apparatus 100 for metal additive manufactured products can be controlled.

Next, a description will be made of pre-measurement for the control using the deposition point temperature and an operation of the additive manufacturing apparatus 100 for metal additive manufactured products in the third embodiment. FIG. 20 is a set of flowcharts for explaining the operation of the additive manufacturing apparatus 100 for metal additive manufactured products in the third embodiment of the present invention. The flowcharts include two parts that are the pre-measurement and processing of metal additive manufactured products.

First, in step S10, a thermogravimetric/differential thermal analysis is performed to calculate the oxidation temperature of the raw material at which the mass increase per 1° C. is 1% or more. Next, in step S20, an oximeter is used to measure the boundary between the shielding gas atmosphere and the air atmosphere. Next, in step S24, the temperature measurement unit 9 is placed to be able to measure the temperature at the boundary and the deposition point temperature.

Next, as pre-processing in step S25, processing is performed at a target output in the present depositing. The deposition point temperature when the temperature at the boundary exceeds the oxidation temperature of the material is measured. In a case where the output may be changed in the present processing, the deposition point temperature is measured similarly by changing the output. The deposition point temperature thus obtained when the temperature at the boundary between the shielding gas atmosphere and the air atmosphere exceeds the oxidation temperature is referred to as a deposition point pseudo oxidation temperature. The pre-measurement is thus completed.

Next, the additive manufacturing apparatus 100 for metal additive manufactured products is controlled to perform processing. Processing is performed on the basis of the control device 1, the processing head 10, the laser oscillator 2, the rotation mechanism 16, and the pre-measurement result described in the first embodiment.

Processing is performed in step S32 while monitoring the deposition point temperature from the start of processing and determining whether the temperature at the measurement point is higher than or equal to the deposition point pseudo oxidation temperature of the material. At the start of processing, the temperature at the deposition point is near the melting point in many cases. In this case, the temperature is lower than or equal to the deposition point pseudo oxidation temperature of the material, so that no control is necessary and the process returns to step S32.

Then, as processing is continued, the deposition point temperature gets close to the deposition point pseudo oxidation temperature. When the deposition point temperature exceeds the deposition point pseudo oxidation temperature, the process proceeds to step S42. In step S42, with the deposition point temperature exceeding the deposition point pseudo oxidation temperature, the processing parameter is changed or processing is stopped, and the process proceeds to step S51. Processing control refers to control selected from at least one of stopping processing to stop the movement of the processing head 10 and the laser irradiation, gradually reducing the output of processing, and slowing the speed of movement of the processing head 10. That is, when the temperature at the measurement point during processing reaches the temperature set on the basis of the oxidation temperature of the material, the control device 1 performs at least one of the control of stopping the output of the heat source with which the deposition region 23 is irradiated, the control of reducing the output, or the control of reducing the speed of movement or stopping the movement of the heat source moving in the deposition region 23.

Next, in step S52, if the deposition point temperature is higher than or equal to the deposition point pseudo oxidation temperature of the material, the control continues to be performed, and upon confirmation that the deposition point temperature is lower than or equal to the deposition point pseudo oxidation temperature, the process proceeds to step S62 of canceling the processing control such as determining that processing can be performed and resuming processing. When processing is resumed, the processing parameter and the like may be changed. Processing is stopped for a moment in the control method described herein, but need not always be stopped. For example, if heat accumulation can be reduced by changing the output that is the parameter affecting heat accumulation, processing need not always be stopped. A determination is made as to whether processing is completed in stage S72, and if processing is to be continued, the process returns to step S32 of performing the temperature measurement point, and processing is performed in a similar flow. If processing is completed, processing is ended.

By repetition of such control and indirect management by the deposition point temperature, it is possible to manufacture the products that are not oxidized without exposure to the region where the shielding gas does not reach when the temperature is higher than or equal to the oxidation temperature.

Hereinafter, with a specific case, the control using the deposition point temperature will be described.

### Seventh Example

Here, the titanium alloy (Ti-6Al-4V) that is easily oxidized will be described. The titanium alloy is used because oxidation thereof is apparent, but another metal material other than the titanium alloy may be used as long as the principle of the present invention is used. As preliminary measurement before processing, steps S10, S20, and S24 of estimating the oxidation temperature of the titanium alloy and the region shielded from the atmosphere by the shielding gas were performed similarly to those in the first example. According to the first example, the oxidation temperature of the titanium alloy is 510° C., and the range of the shielding gas corresponds to the region where the oxygen concentration is 1% or lower.

Next, in step S25, the correlation between the deposition point temperature and the measured temperature at the boundary between the shielding gas atmosphere and the air atmosphere was acquired. The deposition point temperature is obtained by installing the radiation thermometer immediately above the processing head 10 and measuring the temperature at the deposition point. In addition, an environment in which the temperature at the boundary between the shielding gas atmosphere and the air atmosphere can be measured was constructed with reference to the first example.

As an experiment for acquiring the prior correlation, for example, in a case where the experiment was conducted at 1000 W output, the deposition point temperature was about 1800° C. when the measured temperature at an edge of the range covered by the shielding gas exceeded 510° C. The correlation was similarly acquired in a case of 1500 W output, at which the deposition point temperature was about 1900° C., and the deposition point temperature for a certain output was calculated.

Next, the additive manufacturing apparatus 100 for metal additive manufactured products is used to perform processing. First, various installation will be described. The substrate 17 is mounted on the stage 15. The wire 5 is attached to the rotary motor 4 and brought close to the substrate 17 through the wire nozzle. At this time, the wire may or need not be in contact with the substrate 17. When the raw material of the wire, the substrate, and the temperature measurement unit 9 have been installed and the interpass temperature can be measured, processing is started while actually performing control. A tip of the wire is melted with predetermined laser output, feed of the wire, and axial speed, and the melted liquid is deposited. Here, although the main parameters are described, there are also parameters regarding a beam diameter and laser oscillation related thereto.

Here, a case where processing was performed at 1000 W will be described. At the start of processing, the deposition point temperature was about 1700° C., which is near the melting point and lower than or equal to the deposition point pseudo oxidation temperature and from which one can determine that oxidation has not progressed, whereby processing was continued according to step S32. The temperature increased as processing was continued, and the deposition point temperature exceeded the deposition point pseudo oxidation temperature of 1800° C. at a certain point. When the deposition point temperature exceeded the deposition point pseudo oxidation temperature, the process proceeded to step S42 to stop processing, stop the movement of the processing head 10, and stop the oscillation of the laser. The process proceeded to step S52, and a gradual decrease in the measured temperature was confirmed.

Processing may be resumed at any time when the temperature is below the deposition point pseudo oxidation temperature, such as immediately after the temperature has fallen below the deposition point pseudo oxidation temperature or after confirmation that the temperature has dropped sufficiently. Processing may be started at any temperature lower than or equal to the deposition point pseudo oxidation temperature estimated from the pre-measurement. Next, when the temperature has fallen below a predetermined temperature, the process proceeds to step S62 and resumes processing. At this time, the parameter of processing may be changed. Similarly, processing was performed while performing temperature measurement and paying attention that the temperature did not become higher than or equal to the deposition point pseudo oxidation temperature, and when the temperature exceeded the deposition point pseudo oxidation temperature, processing was stopped and then resumed in step S72 after confirmation that the temperature dropped, whereby the products was formed while performing similar control.

An amount of oxygen in the products obtained was measured by the infrared absorption method. The standard for the amount of oxygen in the titanium alloy is set to 0.2 wt % or less, and the amount of oxygen in the products was confirmed to be less than or equal to 0.2 wt % and was found to satisfy the standard.

When such a method is used, the temperature can be inferred by analogy from information on the brightness and the width of a molten pool besides the deposition point temperature.

The configurations illustrated in the above embodiments each merely illustrate an example of the content of the present invention, and thus the techniques of the embodiments can be combined together or combined with another known technique, or the configurations can be partially omitted and/or modified without departing from the scope of the present invention.

### REFERENCE SIGNS LIST

1 control device; 2 laser oscillator; 3 fiber cable; 4 rotary motor; 5 wire; 6 wire spool; 7 gas supply device; 8 pipe; 9 temperature measurement unit; 10 processing head; 11 beam nozzle; 12 wire nozzle; 13 gas nozzle; 14 head driver; 15 stage; 16 rotation mechanism; 17 substrate; 18 deposit; 19 material supply unit; 20a deposition point; 20b deposition point; 21 laser beam; 22 shielding gas; 23 processing region (deposition region); 24 shielding gas atmosphere region; 25 air atmosphere region; 26 boundary between shielding gas atmosphere region and air atmosphere region; 27a oxygen concentration measurement point (deposition point); 27b oxygen concentration measurement point (shielding gas atmosphere region); 27c oxygen concentration measurement point (shielding gas atmosphere region); 27d oxygen concentration measurement point (position where oxygen concentration is 1%); 27e oxygen concentration measurement point (position where oxygen concentration is 1.5%); 28 interpass temperature measurement point; 29 oxidation temperature; 30 interpass temperature measurement; 31 deposition point temperature measurement; 41 CPU; 42 RAM; 43 ROM; 44 external storage device; 45 input/output interface; 46 bus; CL laser center; 100 additive manufacturing apparatus for metal additive manufactured products.

1.-10. (canceled)

11. An additive manufacturing apparatus for metal additive manufactured products, the additive manufacturing apparatus comprising:
a material supplier to supply a material of the metal additive manufactured products to a processing region;
an irradiator to irradiate the processing region with a heat source that melts the material;
a gas supplier to eject a shielding gas to the processing region;
a temperature sensor to measure a temperature at a measurement point in the processing region; and
a controller to perform, when the temperature at the measurement point during processing reaches a temperature set on the basis of an oxidation temperature of the material, at least one of control of stopping output of the heat source with which the processing region is irradiated, control of reducing the output, or control of reducing a speed of movement or stopping the movement of the heat source moving in the processing region, wherein
the temperature sensor measures an interpass temperature that is a temperature of a deposit, which is to be a material of products, or a substrate on which the deposit is deposited, the measurement point is an arbitrary position on the deposit or the substrate, and the temperature set on the basis of the oxidation temperature of the material is the interpass temperature when a temperature at a boundary between a shielding gas atmosphere, which is measured before processing, and an air atmosphere exceeds the oxidation temperature.

12. An additive manufacturing method for metal additive manufactured products, the additive manufacturing method comprising:
supplying a material of the metal additive manufactured products to a processing region;
irradiating the processing region with a heat source that melts the material;
ejecting a shielding gas to the processing region;
measuring a temperature at a measurement point in the processing region; and
performing, when the temperature at the measurement point during processing reaches a temperature set on the basis of an oxidation temperature of the material, at least one of control of stopping output of the heat source with which the processing region is irradiated, control of reducing the output, or control of reducing a speed of movement or stopping the movement of the heat source moving in the processing region, wherein
measuring the temperature measures an interpass temperature that is a temperature of a deposit, which is to be material of products, or a substrate on which the deposit is deposited, the measurement point is an arbitrary position on the deposit or the substrate, and the temperature set on the basis of the oxidation temperature of the material is the interpass temperature when a temperature at a boundary between a shielding gas atmosphere, which is measured before processing, and an air atmosphere exceeds the oxidation temperature.

13. An additive manufacturing apparatus for metal additive manufactured products, the additive manufacturing apparatus comprising:
a material supplier to supply a material of the metal additive manufactured products to a processing region;
an irradiator to irradiate the processing region with a heat source that melts the material;
a gas supplier to eject a shielding gas to the processing region;
a temperature sensor to measure a temperature at a measurement point in the processing region; and
a controller to perform, when the temperature at the measurement point during processing reaches a temperature set on the basis of an oxidation temperature of the material, at least one of control of stopping output of the heat source with which the processing region is irradiated, control of reducing the output, or control of reducing a speed of movement or stopping the movement of the heat source moving in the processing region, wherein
the temperature sensor measures a temperature of products being processed that is formed by melting the material.

14. The additive manufacturing apparatus for metal additive manufactured products according to claim 13, wherein the measurement point is a position that is closer to a position irradiated with the heat source than a boundary between a shielding gas atmosphere by the shielding gas and an air atmosphere is, and the temperature set on the basis of the oxidation temperature of the material is a temperature lower than or equal to the oxidation temperature of the material.

15. The additive manufacturing apparatus for metal additive manufactured products according to claim 13, wherein
the measurement point is a position of a deposition point irradiated with the heat source, and
the temperature set on the basis of the oxidation temperature of the material is a deposition point temperature when a temperature at a boundary between a shielding gas atmosphere, which is measured before shaping, and an air atmosphere exceeds the oxidation temperature.
